(19) United States
(12) Patent Application Publication
(10) Pub. No.: US 2018/0092370 A1
(43) Pub. Date: Apr. 5, 2018

(54) LIQUID AND POWDER DELIVERY SYSTEMS FOR APPLICATION OF ANTIMICROBIALS TO MEAT PRODUCTS

(71) Applicant: ARIZONA BOARD OF REGENTS ON BEHALF OF THE UNIVERSITY OF ARIZONA, Tucson, AZ (US)

(72) Inventors: Sadhana Ravishankar, Tucson, AZ (US); Libin Zhu, Tucson, AZ (US)

(21) Appl. No.: 15/722,941

(22) Filed: Oct. 2, 2017

Related U.S. Application Data
(60) Provisional application No. 62/402,898, filed on Sep. 30, 2016.

(51) Int. Cl. A23B 4/20; A23B 4/30; A23B 4/32; A23L 3/3463; A23L 27/12; A23P 20/18

(52) U.S. Cl. CPC A23B 4/20; A23B 4/30; A23P 20/18; A23L 3/3463; A23L 27/12; A23B 4/32

(57) ABSTRACT

Antimicrobial compositions derived from edible plant sources such as essential oils, their active components, spices and plant extracts have shown antimicrobial effects against a number of foodborne pathogens. The foodborne pathogens of concern in meat and poultry products include Salmonella enterica, Escherichia coli O157:H7 and Listeria monocytogenes. The antimicrobial compositions were applied to a meat surface using liquid or powder electrostatic spray systems to effectively reduce the amount of pathogens on various meat and poultry products.

### CROSS REFERENCE

This application is a non-provisional and claims benefit of U.S. Provisional Application No. 62/402,898, filed Sep. 30, 2016, the specification(s) of which is/are incorporated herein in their entirety by reference.

### FIELD OF THE INVENTION

The present invention relates to natural and plant-based antimicrobials delivered via liquid and powder spray systems to kill pathogens in meat products.

### BACKGROUND OF THE INVENTION

Foodborne pathogens are a significant public health concern with the CDC estimating 48 million Americans experiencing food-based illness each year. Illness incidence rates fluctuate for each type and strain of foodborne pathogen, but the CDC reports no significant change in the overall rate of food-based illness from 2006 to 2014. On the other hand, use of antibiotics in meat production has seen significant public criticism in recent years, sparking fear of antibiotic-resistant bacteria as well as an anti-antibiotic meat movement. Fear of antimicrobial resistance is supported by a significant fraction of experts that espouse the danger as a “major public health crisis.” The threat of antibiotic-resistance due to traditional, synthetic antibiotics could lead to the public turning away from standard antimicrobials, and the threat of foodborne illness could lead to the public to seek an alternative solution.

With the intermixing of trade and consumption of food products across countries, the need for improved food preservation techniques and modes have been a key aspect for food manufacturers and food processors. Coupled with that are the food safety concerns that impact the food, nutrition and health factors of food content marketed today. Consumers are also increasingly interested in preservatives from minimally processed and whole-food servings. For instance, the demand for powdered beverages, health/protein products and health/nutritional bars with natural or no preservatives is constantly on the rise. Due to the current consumer demand for fresh tasting, safe and natural foods with good nutritional quality, food preservation to render processed food products safe for human consumption has become a challenge for the food industry and regulatory agencies. One of the strategies used to achieve food preservation is the use of naturally occurring bio-derived compounds. Many consumers generally prefer natural products over synthetic additives, as they are becoming increasingly aware of the health risks associated with synthetic products. Thus, the food industry is inclined towards natural preservative alternatives to their synthetic counterparts to prevent food spoilage and extend the shelf life of the food products. To meet this need, the food industry may prefer to evaluate the use of natural ingredients in food products.

As the dominance of natural preservatives has been witnessed during the past four to five years, various manufacturers are now shifting their focus to produce natural and organic biopreservatives. Although natural preservatives may be more expensive than their synthetic counterparts, dosage limits of natural preservatives make them more cost-effective overall. Some examples of natural antioxidants include apple polyphenols extract, green and white teas, acerola cherry, astaxanthin, algae, yerba mate (polyphenols), muscadine grape, blueberry, pomegranate and black currant extracts. Lactic acid solutions are currently used in the meat industry as a highly effective antimicrobial agent against key foodborne pathogens. However, lactic acid solutions require a great deal of water to ensure effective antimicrobial action. Thus, there is a need for an effective, natural, and economical solution to the problems of food-borne illness and fear of antibiotic-resistant bacteria.

The present invention provides a novel method for sanitizing the surface of raw meat to kill bacteria as well as improve shelf-life, a practice that is not necessarily related to the antibacterial-related public health threats.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### SUMMARY OF THE INVENTION

In some aspects, the present invention utilizes lactic acid, alone or in combination with compounds derived from edible plant sources such as essential oils, their active components, spices and plant extracts, which have been shown to have antimicrobial effects against a number of foodborne pathogens such as Salmonella enterica (S. enterica), Escherichia coli O157:H7 (E. coli O157:H7), and Listeria monocytogenes (L. monocytogenes). The present invention does not carry the stigma of using traditional, “harsh” antibiotics in food. Furthermore, the method used herein is effective and eschews some of the problems of current food sanitizers (consumer health and cost being chief among them). Because of this, the invention could have greater value than the comparative antimicrobial efficacy suggests.

In other aspects, the present invention includes an electrostatic delivery system which, when implemented properly, can reduce waste of antimicrobial agents and virtually eliminate water requirements, thus saving a substantial amount of water and energy. While both methods include lactic acid as a primary antibacterial, inclusion of other natural antimicrobial agents can reduce the amount of lactic acid necessary for sanitization as well as lend visibility to the “naturalness” of the process.

In addition, the present invention has evaluated the application of plant antimicrobials and lactic acid using two different electrostatic spray systems (liquid and powder) against S. enterica, E. coli O157:H7 and L. monocytogenes on various meat and poultry products. The meats were inoculated with pathogens, treated with the antimicrobial sprays, and stored at refrigeration temperature. Tests showed a decrease in pathogen levels up to 98.4-99.75% depending on the type of pathogen.

One of the unique and inventive features of the present invention is the use of electrostatic spray system for applying antimicrobials by inducing electrostatic binding of charged molecules to both the pathogens and the surfaces of the meats, which can result in better efficacy. The spray system can uniformly coat the meat surfaces, both front and back, even if applied from one side. Thus, lower amounts of antimicrobials can be used in comparison to conventional spray applications. Without wishing to limit the invention to any theory or mechanism, it is believed that the technical feature of the present invention advantageously provides for energy and cost savings in the industry, since the treatment can be done without water (powder system) or in cold water (liquid system). Further still, the present invention may be more environmentally friendly than chlorine-containing antimicrobial agents since no trihalomethanes were formed in the present invention. None of the presently known prior references or work has the unique inventive technical feature of the present invention.

### BRIEF DESCRIPTION OF THE DRAWINGS

The features and advantages of the present invention will become apparent from a consideration of the following detailed description presented in connection with the accompanying drawings in which:

FIG. 1 shows a Kitto Electrostatic Coating (powder spray) system which eliminates pathogens by creating precision electrostatic bonding of antimicrobial powder to meats.

### DESCRIPTION OF PREFERRED EMBODIMENTS

As used herein the term “pathogen” is defined as a microbial form that can cause disease in terms of its ability to produce toxins, enter tissue, colonize, hijack nutrients, and its ability to immunosuppress the host. As used herein the term “antimicrobial agent” is defined as an agent that kills microorganisms or inhibits their growth.

As used herein, the term “extract” is defined as a separation, usually mechanical or chemical, of a substance and/or an active component from the fibrous tissues of the plant. In some embodiments, extracts can be in a liquid or powdered form. For instance, plant material may be treated with a solvent, cold-pressed, or steam distilled to extract and concentrate the active components to form an essential oil of said plant. As another example, the plant material may be dried and then steeped or soaked in a solvent, such as water, that may be cooled, room-temperature, or heated.

As used herein, the term “electrostatic spray systems” is defined as the air-assisted electrostatic sprayers that produce droplets 900 times smaller than those produced by conventional or hydraulic sprayers. After tiny droplets are atomized, they are then given an electrical charge, which are carried via air stream towards the surface to be decontaminated and attach well to the surface. Since the surface is positively charged, they are attracted towards the surface and bind to the surface well.

A non-limiting example of an electrostatic spray system that may be used with the present invention is a Kitto Electrostatic Coating (powder spray) System as described in U.S. Pat. No. 6,312,740. Briefly, the electrostatic spray apparatus for applying electrostatically charged particles of an edible coating material to a surface of a food product item comprises a hopper for containing coating material, said hopper including a fluidizing plate for supporting a quantity of said material, an agitator blade and a lifting blade for agitating and lifting said material to assist in fluidizing the material; a source of pressurized fluidizing air connected to said hopper for travel through said fluidizing plate; a feed tube extending into said hopper and having an end thereof positioned a predetermined distance above said fluidizing plate to permit the withdrawal from said hopper of fluidized material at a selected density; a venturi pump connected to an opposite end of said feed tube to withdraw fluidized material from said hopper; and an application gun having means for creating a corona discharge and connected to receive fluidized material from said venturi pump, said gun directing said fluidized material through said corona discharge to produce charged particles of coating material and directing said charged particles toward a food product item surface.

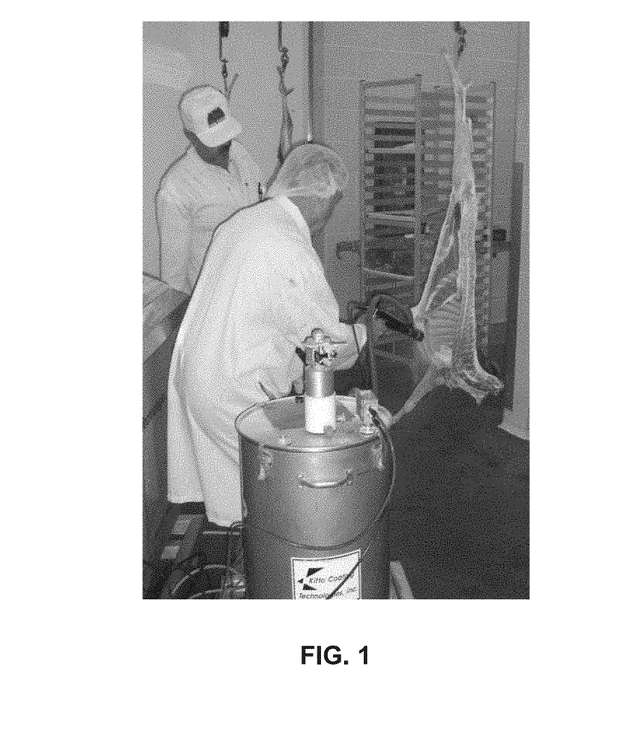

Referring now to FIG. 1, the present invention features a method of reducing microorganisms on meat. In one embodiment, the method may comprise applying an effective amount of an antimicrobial agent to a surface of the meat by spray-treating said surface using a liquid or powder electrostatic spray apparatus. In some embodiments, the antimicrobial agent may comprise lactic acid. In other embodiments, the antimicrobial agent may further comprise a plant extract comprising olive extract, hibiscus extract, or a combination thereof. The effective amount of antimicrobial agent may be determined by methods known in the art, and may preferably comply with standard dosage limits. Without wishing to limit the invention to a particular theory or mechanism, the antimicrobial agent may effectively reduce the microorganism population on the meat surface by about 1 log to about 2.6 logs.

In some embodiments, the liquid electrostatic spray system uses cold water as the liquid medium. In other embodiments, the powder electrostatic spray system is free of water. Without wishing to be bound by a particular theory, the electrostatic spray system atomizes the antimicrobial agent droplets, which are then given an electrical charge, and carried via an air stream towards the meat surface to be decontaminated. Since the meat surface is positively charged, the atomized antimicrobial agent is attracted to the surface and binds well to the surface. In some embodiments, the electrostatic spray system may be more effective than conventional or hydraulic sprayers. In other embodiments, the powder electrostatic spray system may demonstrate better antimicrobial effects against pathogens than the liquid electrostatic spray system.

According to another embodiment, the present invention features an antimicrobial composition for reducing microorganisms on meat. In some embodiments, the antimicrobial composition may comprise lactic acid. In other embodiments, the antimicrobial composition may further comprise a plant extract comprising olive extract, hibiscus extract, or a combination thereof. In preferred embodiments, an effective amount of said antimicrobial composition is applied to a surface of the meat by spray-treatment using a liquid or powder electrostatic spray apparatus. This effective amount may be determined by methods known in the art, and may preferably comply with standard dosage limits. Without wishing to limit the invention to a particular theory or mechanism, the antimicrobial composition may effectively reduce the microorganism population on the meat surface by about 1 log to about 2.6 logs. In other preferred embodiments, the antimicrobial composition is free of chlorine sanitizers, thus eliminating trihalomethanes as a by-product.

In addition to being spray-treated onto meat, the antimicrobial composition may also be used as a food packaging film for the packaging of food products. Without wishing to be bound by a particular theory or mechanism, food packaging film having the antimicrobial composition can provide another method of applying antimicrobials to meat and poultry products, thereby reducing microorganism population and inhibiting food spoilage. Thus, in one embodiment of the present invention, the method of reducing microorganisms on meat may comprise packaging the meat with any of the food packaging films described herein.

In some embodiments, the food packaging film may comprise a film substrate loaded with the antimicrobial composition. For example, the film substrate may be coated or impregnated with the antimicrobial composition. In other embodiments, the film substrate may be a natural edible film, polymeric or metallic film, or a paper-based substrate. For instance, the food packaging film may comprise a natural edible film made from plant sources and incorporated with essential oils or their active components. Examples of food products that may be packaged with the food packaging film include, but are not limited to, meat and poultry products, cereal, and food bars.

Consistent with previous embodiments of the invention, the meat may comprise beef, pork or chicken. However, the meat is not limited to only beef, pork and chicken. Any other meat, such as seafood, i.e. fish, game meats such as elk, goat, bison, deer, and wild poultry can be considered for the purpose of this invention. In other embodiments, the meat may be in a fresh, frozen, or processed form. Examples of processed meat include bacon, ham, and smoked meats.

In preferred embodiments, the antimicrobial agent or composition may be derived from plants. The plant-derived antimicrobial agents or compositions are preferably from edible plant sources. Non-limiting examples of edible plant sources include essential oils, their active components, and spices such as turmeric. In some embodiments, the plant extract may further comprise apple extract, green tea extract, grape seed extract, or combinations thereof. In other embodiments, the antimicrobial agents or compositions may further comprise carvacrol, which is an active component that may be extracted from oregano essential oil or thyme essential oil. However, it is understood that any other edible plant sources that show antimicrobial activities to reduce the amount of pathogens on meat surface can be used to serve the purpose of this invention.

In some embodiments, the microorganisms may be foodborne pathogens. Examples of the foodborne pathogens include, but are not limited to, Salmonella enterica, Escherichia coli O157:H7, and Listeria monocytogenes. In one embodiment, the effective reduction of the amount of Salmonella enterica on the meat surface is about a 2.6 log reduction. In another embodiment, the effective reduction of the amount of Escherichia coli O157:H7 on the meat surface is about a 1.8 log reduction. In some yet another, the effective reduction of the amount of Listeria monocytogenes on the meat surface is about a 1.9 log reduction.

Without wishing to be bounded by a particular theory, the present invention provides a safe, efficient, cost-effective way of treating and inactivating common pathogens on meat products without resorting to unsafe or environmentally harmful antimicrobials such as chlorine. The advantages of the present invention include the following:
Powder and liquid delivery systems can be used with no water or cold water, respectively, and further reduce energy and chemical waste;
Use of natural antimicrobial agents from plants instead of harsher chemicals;
With a 98.4-99.75% reduction in pathogen population after treatment, the present invention kills common pathogens at a rate comparable to most synthetic antimicrobial preservatives.

### EXAMPLES

The following methods are included herein as non-limiting examples only. Equivalents or substitutes are within the scope of the invention.

Meat Products

Beef, pork and bacon were provided by the Food Products and Safety Laboratory, University of Arizona, Tucson, Ariz. Chicken, ham and bologna were purchased from a local grocery store in Tucson, Ariz.

Plant Antimicrobials and Lactic Acid

The plant antimicrobials tested in this study were olive extract, apple extract, grape seed extract, green tea extract, black tea extract, hibiscus tea and carvacrol. The hibiscus calyces were provided by Dr. Divya Jaroni, Southern University Agricultural Research and Extension Center, Baton Rouge, La. The other plant antimicrobials were provided by Dr. Mendel Friedman, USDA-ARS Western Regional Research Center, Albany, Calif. Lactic acid, provided by the Food Products and Safety Laboratory, University of Arizona, Tucson, Ariz., was also tested in this study.

Electrostatic Spray Systems

The antimicrobials were applied using an electrostatic spray system that induces electrostatic binding of charged molecules to both the pathogens and the surfaces of meat and poultry. Powder and liquid spray systems were used in this study. The Kitto Electrostatic Coating (powder spray) System (FIG. 1, Kitto System; Kitto Coating Technologies Inc., Scottsdale, Ariz. U.S. Pat. No. 6,312,740) effectively creates precision electrostatic bonding of antimicrobial powder to meats. Each powder particle is negatively charged when sprayed and tightly binds or envelops the bacteria and meat. A liquid electrostatic spray system from Desert Best Technologies, LLC, AZ was also evaluated.

Evaluation of the Antimicrobial Activities Using the Liquid Spray System

Beef, pork and chicken breast were cut into small pieces (10 g). Beef samples were inoculated with E. coli O157:H7. Pork and chicken samples were inoculated with S. enterica serovar Typhimurium (S. Typhimurium). The inoculation level for both bacteria was 10⁵ CFU/g. The samples were dried for 30 min to allow the bacteria to attach to the surface. The samples were then spray-treated with one of the following antimicrobial solutions using the liquid spray system: 5% lactic acid, 5% apple extracts, 5% green tea extract, 5% grape seed extract, hibiscus tea (1 g hibiscus powder boiled in 2 oz water), and 1.5% carvacrol. Water was used as a control. After the treatments, one batch of samples was taken at day 0 and the other batch of samples was stored at 4° C. for 3 days. The surviving bacteria on meat products were enumerated by plating on Sorbitol MacConkey agar and Xylose Lysine Desoxycholate (XLD) agar, for E. coli O157:H7 and S. Typhimurium, respectively.

Evaluation of Antimicrobial Activities Using the Kitto Powder Spray System

Beef, pork, chicken breast, bologna, ham and bacon were cut into small pieces (10 g). Beef samples were inoculated with E. coli O157:H7 or S. Typhimurium. Pork and chicken samples were inoculated with S. Typhimurium. Ham and bacon samples were inoculated with S. Typhimurium or L. monocytogenes. Bologna samples were inoculated with L. monocytogenes. The inoculation levels for the 3 bacteria were 10⁵⁻⁶ CFU/g. The samples were dried for 30 min to allow the bacteria to attach to the surface. The samples were then spray-treated with one of the following antimicrobial powders using the Kitto System: lactic acid, olive extract, apple extracts, hibiscus powder, grape seed extract, green tea extract, and black tea extract. After the treatments, one batch of samples was taken at day 0 and the other batch of samples was stored at 4° C. for 3 days. The surviving bacteria on meat products were enumerated by plating on Sorbitol MacConkey (SMAC) agar, Xylose Lysine Desoxycholate (XLD) agar and Modified Oxford (MOX) formulation agar for E. coli O157:H7, S. Typhimurium and L. monocytogenes, respectively. Untreated samples were used as controls.

Results

Effectiveness of Plant Antimicrobials and Lactic Acid Against E. coli O157:H7 and S. Typhimurium on Meat Products Using the Liquid Spray System.

The surviving populations of E. coli O157:H7 and S. Typhimurium are shown in Table 1. Among the various antimicrobials, carvacrol solution showed the best antimicrobial activities against both pathogens, compared to water controls. At day 3, carvacrol reduced the E. coli O157:H7 population by 0.3 Log CFU/g on beef samples. For S. Typhimurium, carvacrol showed 0.4 and 0.5 log reduction on pork and chicken, respectively. Hibiscus tea also demonstrated antimicrobial effects in the liquid spray treatment. At day 3, it caused 0.2 and 0.4 log reduction in Salmonella population on pork and chicken, respectively. Green tea extract reduced 0.3 log of Salmonella on chicken at day 3.

TABLE 1
Survival of pathogens (log CFU/g) on meat products
after liquid spray treatments.
Beef inoculated with E. coli O157:H7

| | Day 0 | Day 3 |
|---|---|---|
| water | 4.99 ± 0.14* | 4.58 ± 0.44 |
| lactic acid | 4.95 ± 0.16 | 4.60 ± 0.49 |
| 1.5% Carvacrol | 4.80 ± 0.20 | 4.30 ± 0.62 |
| hibiscus tea | 4.98 ± 0.17 | 4.46 ± 0.59 |
| 5% green tea extract | 4.87 ± 0.24 | 4.58 ± 0.48 |
| 5% grape seed extract | 4.96 ± 0.16 | 4.52 ± 0.49 |
| 5% apple extract | 4.97 ± 0.18 | 4.66 ± 0.36 |

Pork inoculated with S. Typhimurium

| | Day 0 | Day 3 |
|---|---|---|
| water | 5.29 ± 0.42 | 4.83 ± 0.28 |
| lactic acid | 5.22 ± 0.32 | 4.73 ± 0.29 |
| 1.5% Carvacrol | 4.88 ± 0.26 | 4.47 ± 0.27 |
| hibiscus tea | 5.27 ± 0.41 | 4.63 ± 0.20 |
| 5% green tea extract | 5.27 ± 0.33 | 4.71 ± 0.18 |
| 5% grape seed extract | 5.27 ± 0.28 | 4.67 ± 0.17 |
| 5% apple extract | 5.34 ± 0.36 | 4.92 ± 0.12 |

Chicken inoculated with S. Typhimurium

| | Day 0 | Day 3 |
|---|---|---|
| water | 5.24 ± 0.22 | 4.96 ± 0.54 |
| lactic acid | 5.00 ± 0.17 | 4.89 ± 0.55 |
| 1.5% Carvacrol | 4.75 ± 0.15 | 4.50 ± 0.35 |
| hibiscus tea | 5.11 ± 0.30 | 4.58 ± 0.43 |
| 5% green tea extract | 5.17 ± 0.30 | 4.73 ± 0.32 |
| 5% grape seed extract | 5.16 ± 0.31 | 4.92 ± 0.52 |
| 5% apple extract | 5.12 ± 0.30 | 4.79 ± 0.22 |

*Data is shown as Mean ± SD, n = 3.

Effectiveness of Plant Antimicrobials and Lactic Acid Against E. coli O157:H7, S. Typhimurium and L. monocytogenes on Meat Products Using the Kitto Powder Spray System.

The effectiveness of plant antimicrobials and lactic acid powders against E. coli O157:H7 is shown in Table 2. Lactic acid reduced E. coli O157:H7 by 1.1 and 1.2 log CFU/g at day 0 and 3, respectively. Olive extract showed 0.9 log reduction at day 0, and it demonstrated better antimicrobial activities (1.8 log reduction) against E. coli O157:H7 at day 3 than lactic acid. Apple extract and hibiscus also caused 0.7 and 0.8 log reductions, respectively, at day 3.

TABLE 2
Survival of E. coli O157:H7 (log CFU/g) on beef after
the Kitto powder spray treatments.
Beef inoculated with E. coli O157:H7

| | Day 0 | Day 3 |
|---|---|---|
| control | 5.57 | 5.46 |
| lactic acid | 4.49 | 4.25 |
| grapeseed extract | 5.56 | 5.17 |
| apple extract | 5.26 | 4.76 |
| olive extract | 4.65 | 3.67 |
| green tea extract | 5.67 | 5.48 |
| black tea extract | 5.78 | 5.44 |
| hibiscus | 5.13 | 4.63 |

Table 3 shows the surviving populations of S. Typhimurium on meat products after the powder spray treatment. Generally, lactic acid powder showed the best effects among the antimicrobials used, followed by olive extract. Lactic acid caused 0.6-2.0 and 1.0-2.6 log reductions on various meat products at day 0 and 3, respectively. Olive extract also reduced Salmonella population by 0.3-1.8 and 0.7-1.7 log CFU/g at day 0 and 3, respectively. Hibiscus powder showed 0.5-0.9 and 0.5-1.2 log reduction at day 0 and 3, respectively, on various meat products except ham, on which only 0.2 log reduction was seen at day 3. Apple extract slightly (no more than 0.5 log CFU/g) reduced Salmonella on beef, pork, chicken and ham, but on bacon there were 1.1 and 0.7 log reductions at day 0 and 3, respectively. Green tea and black tea extract also showed some antimicrobial effects on pork and chicken, but the reduction was low (<0.5 log CFU/g).

TABLE 3
Survival of S. Typhimurium (log CFU/g) on meat
products after the Kitto powder spray treatments.
Beef inoculated with S. Typhimurium

| | Day 0 | Day 3 |
|---|---|---|
| control | 5.45 | 5.15 |
| lactic acid | 3.81 | 2.54 |
| grapeseed extract | 5.16 | 5.12 |
| apple extract | 5.10 | 4.91 |
| olive extract | 4.48 | 3.50 |
| green tea extract | 5.49 | 5.56 |
| black tea extract | 5.51 | 5.63 |
| hibiscus | 4.76 | 4.09 |

Pork inoculated with S. Typhimurium

| | Day 0 | Day 3 |
|---|---|---|
| control | 4.94 | 5.20 |
| lactic acid | 4.10 | 3.82 |
| grape seed extract | 4.84 | 4.89 |
| apple extract | 4.70 | 5.00 |
| olive extract | 3.90 | 3.50 |
| green tea extract | 4.63 | 4.83 |
| black tea extract | 4.73 | 4.89 |
| hibiscus | 4.45 | 4.00 |

Chicken inoculated with S. Typhimurium

| | Day 0 | Day 3 |
|---|---|---|
| control | 5.51 | 5.19 |
| lactic acid | 3.64 | 3.81 |
| grape seed extract | 5.12 | 5.00 |
| apple extract | 4.96 | 4.88 |
| olive extract | 3.67 | 3.82 |
| green tea extract | 5.08 | 5.15 |
| black tea extract | 5.03 | 5.11 |
| hibiscus | 4.61 | 4.72 |

Ham inoculated with S. Typhimurium

| | Day 0 | Day 3 |
|---|---|---|
| control | 5.45 | 5.48 |
| lactic acid | 4.81 | 4.45 |
| olive extract | 5.17 | 4.79 |
| hibiscus | 5.47 | 5.24 |
| apple extract | 5.51 | 5.53 |

Bacon inoculated with S. Typhimurium

| | Day 0 | Day 3 |
|---|---|---|
| control | 5.48 | 5.26 |
| lactic acid | 3.53 | 3.46 |
| olive extract | 4.00 | 4.05 |
| hibiscus | 4.60 | 4.69 |
| apple extract | 4.41 | 4.58 |

Table 4 shows the surviving populations of L. monocytogenes on ham, bacon and bologna after the powder spray treatment. Lactic acid powder showed 1.0-1.7 and 0.8-1.8 log reductions at day 0 and 3, respectively. Olive extract caused 0-1.3 log reductions at day 0, and 0.6-1.9 log reductions in L. monocytogenes population at day 3.

TABLE 4
Survival of L. monocytogenes (log CFU/g) on
meat products after the Kitto powder spray treatments.
Bologna inoculated with L. monocytogenes

| | Day 0 | Day 3 |
|---|---|---|
| control | 5.47 | 5.29 |
| lactic acid | 3.98 | 3.97 |
| grapeseed extract | 5.44 | 5.46 |
| apple extract | 5.15 | 4.95 |
| olive extract | 5.53 | 4.05 |
| green tea extract | 5.61 | 5.74 |
| black tea extract | 5.57 | 5.76 |
| hibiscus | 5.48 | 5.11 |

Ham inoculated with L. monocytogenes

| | Day 0 | Day 3 |
|---|---|---|
| control | 6.50 | 6.64 |
| lactic acid | 5.54 | 5.88 |
| olive extract | 5.58 | 6.01 |
| hibiscus | 6.18 | 6.23 |
| apple extract | 6.14 | 6.17 |

Bacon inoculated with L. monocytogenes

| | Day 0 | Day 3 |
|---|---|---|
| control | 6.55 | 6.69 |
| lactic acid | 4.82 | 4.89 |
| olive extract | 5.24 | 4.79 |
| hibiscus | 6.16 | 6.25 |
| apple extract | 5.79 | 5.89 |

### CONCLUSIONS

The results from this study demonstrated that plant antimicrobials and lactic acid effectively reduced E. coli O157:H7, S. Typhimurium and L. monocytogenes on meat products when used with powder and liquid spray systems. After the treatments, there were up to 2.6, 1.8 and 1.9 log reductions on S. enterica, E. coli O157:H7, and L. monocytogenes, respectively. In general, the Kitto powder spray system showed better effects against pathogens than the liquid spray system. Without wishing to be bound by theory, the novel applications of the present invention can help the food industry save energy since the treatments can be done using cold water (liquid system) or without water (powder spray system).

Without wishing to be bound by theory, it was found that lactic acid, olive extract and hibiscus were the most effective ones among the antimicrobials tested in this study. Since the extracts are edible, there is no need to wash them off, and the powders are readily absorbed onto the meat surface within 24 hours, leaving no trace of powders. In addition, the meat sensory properties are not expected to be affected. Plant extracts can also offer other health benefits to consumers, and may further enhance the flavor of the meat and poultry products.

Compared to the use of chlorine, which can generate potentially toxic trihalomethanes, the present treatments are more environmentally friendly. The proposed applications may also be user friendly, causing no skin irritation or cloth bleaching. These applications are very economical costing only few cents/lb of meat, apart from the initial investment in the equipment. Further still, since many plant extracts are inexpensive industrial waste by-products, this may further improve cost-efficiency.

As used herein, the term “about” refers to plus or minus 10% of the referenced number.

The disclosures of the following U.S. patents are incorporated in their entirety by reference herein: U.S. Pat. No. 6,312,740.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Reference numbers recited in the claims are exemplary and for ease of review by the patent office only, and are not limiting in any way. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

The reference numbers recited in the below claims are solely for ease of examination of this patent application, and are exemplary, and are not intended in any way to limit the scope of the claims to the particular features having the corresponding reference numbers in the drawings.

### REFERENCES

1. “Methods for washing carcasses, meat, or meat product with medium chain peroxycarboxylic acid compositions”, Victor Fuk-Pong Man, Joshua Paul Magnuson, U.S. Pat. No. 7,504,124 B2.
2. “Antimicrobial compositions for use on food products”, Timothy Allen Gutzmann, Scott L. Burnett, Richard Keith Staub, Erin Mertz, Seth Young Raley, Weniger, US20100297316 A1.
3. “Pressurized decontamination of meat using carbonic acid”, Anthony J. M. Garwood, WO2003101210 A1.
4. “Method and apparatus for antimicrobial treatment of meat trimmings for subsequent grinding”, Wayne Larson, WO2012119005 A3.
5. “Meat product packaging”, Ivan Robert Taft, William Duncan Potter, WO2001049121 A1.
6. “Antimicrobial compositions for meat processing”, Carl J. Knueven, US20110086146 A1.
7. “Antimicrobial composition and method for food products”, Richard A. White, WO1998033391 A1.
8. “Antimicrobial treatment system and method for food processing”, Donald Bernstein, Marc Bernstein, Michael Bernstein, Thomas Lonczynski, James L. Marsden, John Mekilo, Timothy Michalesko, Kurt Sorensen, US20100323072 A1.
9. “Method for steam pasteurization of meat”, Robert C. Wilson, Jerome D. Leising, John Strong, Jon Hocker, Jerry O'Connor, U.S. Pat. No. 5,711,981 A.
10. “Antimicrobial food packaging in meat industry”, Stefania Quintavalla, Loredana Vicini, Meat Science, 62: 373-380 (2002).
11. “Antimicrobial Activity of Chitosan Films Enriched with Essential Oils”, Svetlana Zivanovic, Shuang Chi, Ann F. Draughon, Journal of Food Science, 70(1): M45-51 (2005).
12. “Antimicrobial effects of selected plant essential oils on the growth of a Pseudomonas putida strain isolated from meat”, Mounia Oussalah, Stephane Ceillet, Linda Saucier et al. Meat Science, 73(2): 236-244 (2006).
13. “Antibacterial mechanism of the action of Enteromorpha linza L. essential oil against Escherichia coli and Salmonella Typhimurium”, Jayanta Patra, Gitishree Das, Kwang-Hyun Baek, Botanical Studies, 56: 13 (2015).
14. “Antioxidant and antimicrobial effects of dietary supplementation with rosemary diterpenes (carnosic acid and carnosol) vs vitamin E on lamb meat packed under protective atmosphere”, J Ortuño, R Serrano, S Bañón, Meat Science, 110: 62-69 (2015).
15. “Antimicrobial property and microstructure of micro-emulsion edible composite films against Listeria”, Mingming Guo, Tony Jin, Madhav Yadav et al. International Journal of Food Microbiology, 208: 58-64 (2015).
16. “Application of a novel antimicrobial coating on roast beef for inactivation and inhibition of Listeria monocytogenes during storage”, Jing Yuan et al, Microbiology, 211: 66-72 (2015).
17. “Comprehensive Review on Application of Edible Film on Meat and Meat Products: An Eco-friendly Approach”, Pramila Umaraw, Akhilesh Verma, Critical Reviews in Food Science and Nutrition, 10.1080/10408398.2014.986563 (2014).

What is claimed is:

1. A method of reducing microorganisms on meat, said method comprising applying an effective amount of an antimicrobial agent to a surface of the meat by spray-treating said surface using a liquid or powder electrostatic spray apparatus; wherein said antimicrobial agent comprises lactic acid, alone or in combination with a plant extract, said plant extract comprising olive extract, hibiscus extract, or a combination thereof; wherein the antimicrobial agent effectively reduces the microorganism population on the meat surface by about 1 log to about 2.6 logs.

2. The method of claim 1, wherein the liquid electrostatic spray system uses cold water as a solvent medium.

3. The method of claim 1, wherein the powder electrostatic spray system is free of water.

4. The method of claim 1, wherein the meat comprises beef, pork, chicken, fish, or game meat, in fresh, frozen, or processed form.

5. The method of claim 1, wherein the plant extract further comprises apple extract, green tea extract, grape seed extract, or combinations thereof.

6. The method of claim 1, wherein the plant extract further comprises carvacrol extracted from oregano essential oil or thyme essential oil.

7. The method of claim 1, wherein the microorganisms are foodborne pathogens.

8. The method of claim 7, wherein the foodborne pathogens are Salmonella enterica, Escherichia coli O157:H7, or Listeria monocytogenes.

9. The method of claim 8, wherein the antimicrobial agent effectively reduces the population of Salmonella enterica on the meat surface by about 2.6 logs.

10. The method of claim 8, wherein the antimicrobial agent effectively reduces the population of Escherichia coli O157:H7 on the meat surface by about 1.8 logs.

11. The method of claim 8, wherein the antimicrobial agent effectively reduces the population of Listeria monocytogenes on the meat surface by about 1.9 logs.

12. An antimicrobial composition for reducing microorganisms on meat, said antimicrobial composition comprising lactic acid, alone or in combination with a plant extract, said plant extract comprising olive extract, hibiscus extract, or a combination thereof; wherein an effective amount of said antimicrobial composition is applied to a surface of the meat by spray-treatment using a liquid or powder electrostatic spray apparatus; wherein the antimicrobial composition effectively reduces the microorganism population on the meat surface by about 1 log to about 2.6 logs.

13. The composition of claim 12, wherein the plant extract further comprises apple extract, green tea extract, grape seed extract, oregano essential oil containing carvacrol, thyme essential oil containing carvacrol, or combinations thereof.

14. The composition of claim 12, wherein the microorganisms are foodborne pathogens, wherein the foodborne pathogens are Salmonella enterica, Escherichia coli O157:H7, or Listeria monocytogenes.

15. The composition of claim 14, wherein the composition effectively reduces the population of Salmonella enterica on the meat surface by about 2.6 logs.

16. The composition of claim 14, wherein the composition effectively reduces the population of Escherichia coli O157:H7 on the meat surface by about 1.8 logs.

17. The composition of claim 14, wherein the composition effectively reduces the population of Listeria monocytogenes on the meat surface by about 1.9 logs.

18. A food packaging film for use in packaging of food products, comprising a film substrate loaded with the antimicrobial composition of claim 12.

19. The food packaging film of claim 18, wherein the film substrate is coated or impregnated with the antimicrobial composition.

20. The food packaging film of claim 18, wherein the film substrate is a natural edible film.
